(19) United States
(12) Patent Application Publication
(10) Pub. No.: US 2020/0007464 A1
(43) Pub. Date: Jan. 2, 2020

(54) METHOD AND MANAGEMENT SYSTEM OF DISTRIBUTED COMPUTATION

(71) Applicant: NATIONAL CHIAO TUNG UNIVERSITY, Hsinchu (TW)

(72) Inventors: Wei-Cheng LO, Hsinchu (TW); Yu-Hung CHEN, Hsinchu (TW); Shun-Yu JHONG, Hsinchu (TW)

(21) Appl. No.: 16/456,691

(22) Filed: Jun. 28, 2019

(30) Foreign Application Priority Data
Jun. 29, 2018 (TW) 107122679

(51) Int. Cl. H04L 12/911; G06Q 10/06; H04L 9/06; G06Q 30/02

(52) U.S. Cl. CPC H04L 47/821; H04L 47/748; H04L 47/822; H04L 2209/38; H04L 9/0643; G06Q 30/0206; G06Q 10/06315

(57) ABSTRACT

A method of distributed computing, wherein the management system includes a plurality of data temporary storage nodes. The user application connects to a neighboring data temporary storage node and uploads the project data need to be processed. The data temporary storage node publishes the tasks of the project in a blockchain network, examines the project and evaluates the processing work. After the user application approves the proposal of processing fees from the data temporary storage node, the data temporary storage node distributes the data of project tasks to the computing resources undertake the project tasks respectively. The computing resources in the blockchain network connect to the neighboring data temporary storage nodes and undertake project tasks respectively. When a computing resource completes the processing of a project task before the deadline of the project task, the neighboring data storage temporary node will transfer the processing fee and issue a work certification to the computing resource. In the overall system, the records of projects uploading, tasks assignments, results of task processing, fee transferring, and exceptions/errors are stored in blockchain, thus the data security is ensured and the costs and risks of joining parties are reduced.

### CROSS-REFERENCE TO RELATED APPLICATIONS

This Non-provisional application claims priority under 35 U.S.C. § 119(a) on Patent Application No(s). [107122679] filed in Taiwan Jun. 29 2018, the entire contents of which are hereby incorporated by reference.

### FIELD OF THE INVENTION

The disclosure of invention relates to methods and management systems of distributed computing.

### BACKGROUND OF THE INVENTION

In recent years, decentralized blockchain technology has become a new focus of the information industry. At present, the typical blockchain application is digital currency. After a large number of distributed operations, the transaction record of digital currency will be added to the blockchain, to each computer that has been certified for trading and recording. Therefore, activities involving asset issuance, transfer transactions, or smart contracts all need a large amount of decentralized computing. Currently, a large number of computing resources from the Internet are joined to the blockchain. However, there is still a lack of an efficient decentralized management system that can allow users who need performing computing tasks to upload computing tasks and find computing resources that can provide computing power, and can let computing resources to receive computing tasks corresponding to its computing power and contribution, thus to efficiently obtain rewards.

### BRIEF SUMMARY OF THE INVENTION

The objective of the disclosure is to provide an efficient methods and management systems of distributed computing that can allow users who need performing computing tasks to upload computing tasks and find computing resources that can provide computing power, and let computing resources to receive computing tasks corresponding to its computing power and contribution, thus to efficiently obtain rewards. This method and management system of distributed computing must have functions of detecting abnormalities or errors, and recording the backup of distributed computing data, so as to avoid the occurrence of system idling of the damaged distributed computing results due to abnormal or error.

In some embodiments of the present disclosure, a computing project processing method includes the following steps: a user application provides dividable project data, the project data includes a project program and a project code, and the user application or at least one of a plurality of neighboring data temporary storage node segments the project data into a plurality of project tasks, wherein each of the project tasks has a task code and the project code.

The user application uploads the dividable project data or the project tasks with a project execution file to the at least one neighboring data temporary storage node.

The user application receives a project processing cost value from the at least one neighboring data temporary storage node; preferably, the user application further receives a project processing time.

If the user application approves the project processing cost value from the project processing time for the at least one neighboring data temporary storage node, the at least one of a plurality of neighboring data temporary storage node respectively connects to at least one computing resources, then publishes and records on a blockchain network, the at least one computing resource receives one of the project tasks and the project execution file to compute from the blockchain network.

The at least one neighboring data temporary storage node receives the project task computing results from the at least one computing resource, wherein the project task computing results respectively have the task code and the project code. The at least one neighboring data temporary storage node checks the project task computing results according to the task code. The neighboring data temporary storage node publishes a work certificate to the at least one computing resource, and records the work certificate in the blockchain network.

The user application receives a plurality of project task computing results returned by the at least one neighboring data temporary storage node, and checks whether the project code in the respective project task computing results is consistent or not.

The user application combines the project task computing results according to the task code, thus to generate a project processing result, and checks whether the project processing result meets the dividable project data.

If the user application checks that the project processing result is correct, the user application pays the project processing cost value from an account, wherein the account belongs to a user who passes an identity authentication. The user application records a payment record of the project processing cost value in the blockchain network.

The user who passed the identity authentication is allowed to access the project processing result.

In an embodiment of the present disclosure, a user application device of a distributed computing system for executing a user application program comprises an identity authentication module, a user interface, a project data processing module, and an asset account management module.

The identity authentication module authenticates a user identity; the user interface is enabled when the user passed the identity authentication through the identity authentication module; the project data processing module generates a project data comprising a project code according to the user operation for the user interface; and the asset account management module links to an account of the user.

The project data processing module connects to at least one of a plurality of neighboring data temporary storage node, and performs the following steps: uploading the project data or a plurality of project tasks generated by the segmentation processing of the project data to the at least one neighboring data temporary storage node, and publishing the project tasks via a blockchain network; receiving a plurality of project task computing results from the at least one neighboring data temporary storage node, checking whether the project code in the respective project task computing results is consistent or not, and returning a verification success message to the plurality of neighboring data temporary storage nodes if the respective project task computing results have the project code; confirming whether the project task computing results have been completely received, and if the project task computing results have been completely received, combining the project task computing results; and setting the user is accessible to the project task processing result.

In an embodiment of the disclosure, a data temporary storage node of a distributed computing system comprises a node monitoring module, a project task receiving module, a project task processing module, a data index management module, and a blockchain data module.

The node monitoring module detects a working state of at least one neighboring data temporary storage node; the project task receiving module receives a project data or a plurality of project tasks from at least one user application or the neighboring data temporary storage node, wherein the project data or the project tasks have a project code; the computing resource management module detects a working state of at least one computing resource, and calculates a computing power of the at least one computing resource, wherein the computing resource connects to the data temporary storage node; the project task processing module determines whether the at least one computing resource can process the project data or the project tasks received by the project task receiving module according to computing power of the at least one computing resource calculated by the computing resource management module, and assigns one of the project tasks to one of the at least one computing resource or the neighboring data temporary storage node; the data index management module updates a data list index according to the project data or the project tasks received by the project task receiving module, wherein a part of the data list index represents the project code; and the blockchain data module records the data list index and information regarding the assignment between one of the project tasks and one of the at least one computing resource or the neighboring data temporary storage node to a blockchain network, wherein the at least one computing resource belongs to the blockchain network.

In the above embodiments, in the method and the management system of distributed computing of the present disclosure, the upload of project data, the assignment of project tasks, the report of task results, the payment and collection of rewards, and other abnormal errors are recorded in the blockchain, such that the computing data and transaction security are ensured, and the risks and costs of all users and computing devices can be reduced.

Furthermore, in the method and management system of distributed computing of the present disclosure, the user application can freely connect to the neighboring data temporary storage node to upload the project data or task to be processed, and the data temporary storage node releases the project data or task in the blockchain, and searches for computing resources or other data temporary storage nodes for processing. The computing resources can also freely connect to the neighboring data temporary storage nodes for registration and undertake project tasks. After the project task is completed, the rewards and the work certificate can be received from the data temporary storage node. The data temporary storage nodes can also detect the state and backup data for synchronization with each other. Therefore, the method and management system of distributed computing of the present disclosure can ensure the data accuracy, and maintain a good robustness even when any device has an abnormality or disconnection.

Methods of distributed computing may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a structural diagram of a distributed management system according to an embodiment of the present invention;

FIG. 2A and FIG. 2B are flowcharts showing the steps of a method for a user to upload a project in an embodiment of the present invention;

FIG. 3 is a flow chart of a method for a user to register a computing resource according to an embodiment of the present invention;

FIG. 4A and FIG. 4B are schematic diagrams showing the steps of synchronizing the data temporary storage node with other devices or nodes according to an embodiment of the present invention; and

FIG. 5A to FIG. 5D are flow charts showing the steps of processing a project of the distributed computing method in an embodiment of the present invention.

### DETAILED DESCRIPTION OF THE INVENTION

The embodiments of the present disclosure are disclosed in the following drawings, and for the purpose of illustration. However, it should be understood by those skilled in the art that, in the embodiments of the disclosure, these practical details are not necessary, and therefore are not applied to limit the disclosure.

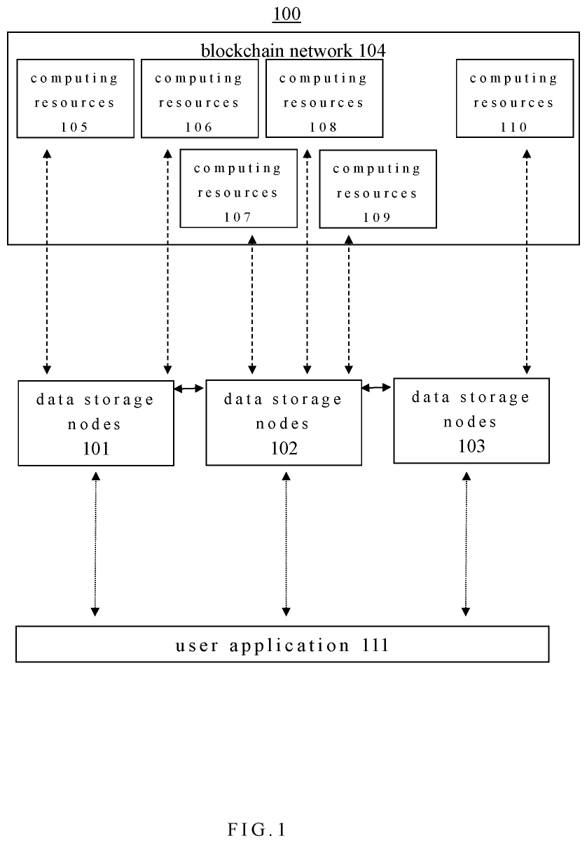

FIG. 1 is a structural diagram of a distributed management system according to an embodiment of the present invention. As shown in FIG. 1, the distributed management system 100 of the present invention has a plurality of data temporary storage nodes 101, 102, and 103, which respectively connect to computing resources 105 to 110 in the blockchain network 104. The data temporary storage nodes 101, 102 and 103 also connect to the user application 111. The foregoing connection method includes direct connection or connection through a network node such as a relay network or a server, as long as the data transmission in the system can be safely performed, and related details are omitted here.

The following is a detailed description of the various parts of the distributed management system of the present invention:

First, the user application: the user application side is an application executable by a general computer, a tablet computer or a smart phone, and has a user interface, an identity authentication module, a project data editing module, and a project data processing module. A user must pass the identity authentication through the identity authentication module, thus to enable the user application. The project data processing module can connect to different data temporary storage nodes to upload or download data. For example, when the user application is an installed application of the smart phone, it can connect to the closest data temporary storage node to upload the project data. After the project data is processed, it can connect to each data temporary storage node with the assigned project task to receive the project task result. The project data editing module has a program editing function. The user can write a project code that requires arithmetic processing via the user interface. The project code can be compiled into a project execution file by the user application or the data temporary storage node. The project execution file and the project data pending for processing can be segmented into multiple project tasks for simultaneous calculation. For example, the project program is a big data statistical method, and the project data pending for processing is the big data. After they are segmented into project tasks, the data temporary storage node can search for computing resources for computing. The project data may also contain only a link to the data pending for processing, rather than all the data itself. The data temporary storage node or the computing resource can obtain the project data pending for processing via the link.

In some embodiments of the present invention, the user application further comprises an asset account management module. When the user application uploads the project data pending for processing to the data temporary storage node, it waits for the data temporary storage node to evaluate the required computing resources for processing the project. The computing resources may be the total computing power, the possible task segmentation mode or the distributed computing task allocation object. Then, the data temporary storage node returns the cost quotation required for processing the project to the user application. The user can decide whether to agree the cost quotation and time for computing. After the user agrees, the data temporary storage node will start the task assignment. When the user application receives the project task computing result, the project data processing module will call the asset account management module to pay. If the user disagrees with the quotation, the user can re-edit the project program, select the data to be processed, segment the project task or use other means to change the amount of calculation required for the project, or ask the data temporary storage node to assign the project task in different pricing methods. For example, the data temporary storage node can ask the computing resources undertaking the project task do not fully operate, and operate only when the computing resources are idle, or ask the computing resources only operate using the graphics processor, and the cost quotation is re-evaluated by the data temporary storage node.

In some embodiments of the present invention, the project data processing module further has a project data segmentation function. Before the project data processing module uploads the project data to the data temporary storage node, the project data processing module will decide whether to execute the project data segmentation function according to a user setting or a processing mode selected in real time, and then segment and upload the project data to the data temporary storage node. If the project data processing module does not segment the project data, the project data is segmented by the data temporary storage node after uploading, and then dispatched to other data temporary storage nodes or computing resources for processing. The project data segmentation function can segment the project data into multiple task data of equal size, or perform unequal task segmentation according to the user's settings.

In some embodiments of the present invention, the segmented task data comprises a project code, a task code, project initiator information, a project description, a project profile, a project file size, a project program compilation executable file, an upload time, and the like. The project data processing module has an encryption and decryption processing module that performs multiple encryption processing methods. Each task data is processed by at least one encryption algorithm before being uploaded to the data temporary storage node.

In some embodiments of the present invention, after each data temporary storage node completes the computing of the assigned task data, the task result is returned to the specific user application. When the user application receives the task results returned by each data temporary storage node, the project data processing module performs the following steps: (1) comparing and verifying whether the task result belongs to the assigned project task; (2) returning a verification success message to the data temporary storage node after the task data is verified; (3) receiving the project task processing result, and confirming whether the task result has been completely received, for example, the task result has multiple files or multiple pieces of data, and which are respectively transmitted to the user application; (4) if the task result has been completely received, combining and decrypting the task results, for example, the several project task results are combined according to the task code to obtain a project task processing result, or multiple pieces of data with the same task code are combined into a complete project task processing result; (5) asking the asset account management module to pay the project task processing fee from the user account; (6) after paying the fee, setting the user has a right to access, use or own the project computing result.

Each of the above modules is a software subroutine executed on the user device, or the software is matched with the hardware to implement the above functions of the user application.

Second, the data temporary storage node: in the distributed management system of the present invention has a plurality of data temporary storage nodes, the data temporary storage node has a node monitoring module and a project task receiving module. The node monitoring module will detect whether other neighboring data temporary storage nodes are working normally for distributing redundant project data or receiving project data that other data temporary storage nodes need to process. The project task receiving module will recognize whether the received data is uploaded by the user application or it is the project data transferred from the other data temporary storage node, or recognize whether the received data is the project task processing result replied from a computing resource under the control of the data temporary storage node, and then call other module for processing.

The data temporary storage node has a computing resource management module. The computing resource management module is responsible for monitoring and managing each computing resource, and the computing resource can independently connect to the data temporary storage node to request registration, so as to undertake the project task published by the data temporary storage node. If the computing resource management module finds that the computing power of a computing resource is too low, the registration of the computing resource can be rejected. If the computing resource management module finds that the idle computing power in the working state of the computing resource is too low, the project data is not distributed to the computing resource until its idle computing power is restored. If one computing resource is repeatedly determined to be overdue and no response, the computing resource management module determines that the computing resource is offline or not in the management scope. If a computing resource undertaking a project task is overdue several times, the computing resource management module determines that the computing resource fails to compute the project task. The computing resource management module also records the state of the neighboring computing resources to evaluate the sum of the computing powers available in the current management scope of the data temporary storage node, thereby assisting the project task processing module to determine whether the computing resources within the management scope of the data temporary storage node are sufficient to undertake the project separately, and decide how to segment the project data and allocate the segmented project tasks to different computing resources when receiving the project uploaded by the user application.

The data temporary storage node has a project task processing module, which is responsible for processing the project task uploaded by the user and the project task of the computing resource, and has the function of segmenting the project data into project tasks. For example, since different computing resources have different computing processing capabilities, the project task processing module can segment the project data according to the computing resource with the worst available computing power in the management scope of the data temporary storage node, so that the computing resource with the worst available computing power can undertake and process the project task, and avoid idle. The project task processing module may also segment the project data according to the type of maximum available computing resource in the management scope of the data temporary storage node. For example, the maximum computing power available in the management scope is the number of computing resources of the A unit, and the number of computing resources is larger than other computing capabilities. The project data can be segmented according to the computing power of the A unit to obtain project tasks, and the size of the segmentation unit can be dynamically adjusted, and is determined according to the state of the computing resources within the management scope at that time.

In some embodiments of the present invention, if all of the computing resources within the management scope of a data temporary storage node have been assigned a project task, and there is no available computing power to undertake a project task, the project task processing module of the data temporary storage node will segment the undistributed part of the project data to be processed, and transfer the segmented project data to be processed to other data temporary storage nodes according to the state of the other data temporary storage node monitored by the node monitoring module. The other data temporary storage nodes can segment the project data according to the computing resources in their respective management scope, and perform subsequent assignment and processing. In some embodiments of the present invention, the project task processing module may also segment the project data to be processed into project tasks, and then transfer the project tasks to one or more data temporary storage nodes. Additionally, if the user application segments the project data before uploading it, the data temporary storage node will receive the segmented project task, so the data temporary storage node does not need to perform the segmentation, and only needs to find the computing resources that can undertake the task.

In some embodiments of the present invention, the project task processing module segments the project data into equal-sized project tasks. The segmented task data comprises a project code, a task code, project initiator information, a project description, a project profile, a project file size, a project program compilation executable file, an upload time, and the like. The project task processing module has an encryption and decryption processing module that performs multiple encryption processing methods. Each task data is processed by at least one encryption algorithm before being assigned to the computing resources or transferred to other data temporary storage nodes.

In some embodiments of the present invention, the project task processing module has a project data evaluation sub-module. When receiving the project data or project task uploaded by the user application, the project data evaluation sub-module will perform an evaluation based on the data amount, thus to obtain the estimated total computing power required for the processing operation. The project data evaluation sub-module will return the evaluation and payment information to the user application. In some embodiments of the present invention, the project data evaluation sub-module performs the evaluation after the project data is segmented. The project data evaluation sub-module randomly selects the segmented project task data to evaluate how much computing power is required, and detects whether the data contains errors or malicious code, such as infinite loops or other malicious code. If the evaluation fails or no result when timeout, the project data evaluation sub-module will automatically generate a project error message to inform the user application that the project data has a problem. If the user application does not confirm receipt of the project error message, a manager is notified to respond in other ways.

In some embodiments of the present invention, if a malicious code is found in project data during the evaluation of the data temporary storage node, the evaluation will be stopped, and the project task receiving module is notified to temporarily disable the uploading permission of the uploaded user application, or perform other treatments, such as adding the user application to the watch list or blacklist, freezing the asset account of a user corresponding to the user application, notifying the other data temporary storage node, canceling the authentication of the user application and rejecting the connection between the user application and the data temporary storage node, rejecting other usage behaviors of the user corresponding to the user application, and so on.

In some embodiments of the present invention, a computing resource may request a project task from a data temporary storage node, and indicates how much idle computing power is available. The computing resource management module of the data temporary storage node is responsible for registering the state of the computing resource. The project data evaluation sub-module estimates the time required for the computing resource to complete the project task according to the idle computing power in the computing resource state registered in the computing resource management module, and sets a deadline for computing the project task. The project task processing module then assigns the project task to the computing resource after related evaluation is completed.

If the computing resource does not return the computing result after the deadline, and the project task processing module cannot find the backup of the computing result from the blockchain via the blockchain data module, the project task processing module will regard the project task as a computing failure, and the project task corresponding to the computing result is re-dispatched. A project task can be assigned to only one set of computing resources, or can be assigned to multiple sets of computing resources. The project task processing module can determine how to dispatch the project task according to the computing requirement and progress.

After the project task processing module sends a segmented project task to the computing resource, a monitoring procedure is established for the computing resource, and the monitoring procedure includes; (1) real-time monitoring the computing deadline is present or not. If the deadline is preset and no computing result is returned from the computing resource, the project task processing module searches for the backup of the project task computing result in the blockchain via the blockchain data module. If the backup cannot be found, it is regarded as a computing failure, and the project task processing module re-assigns the project task to other computing resources; (2) monitoring whether the maximum number of assignments of a single task is exceeded or not. The same task can be allocated to different computing resources simultaneously in the distributed computing. However, the number of assignments of a single task needs to be set, in order to avoid excessively repeating allocations for the same task to waste computing resources. When a project task is assigned to a computing resource and receive a confirmation regarding the acquisition of the project task from the computing resource, the monitoring procedure adds one to the number of assignments for the project task. When the assigned value is equal to the upper limit of the number of assignments, the project task will no longer be dispatched by the project task processing module; (3) uploading related information of the project task from the blockchain data module to the blockchain, wherein the information comprises a computing resource number, project task information, an allocation time, a deadline, and so on; (4) regularly monitoring and receiving the state of each computing resource within the management scope of the data temporary storage node, and recording it in the computing resource management module; and (5) waiting for the task result from the computing resource.

The data temporary storage node has a data index management module. The data list is managed by the data index management module and a data list index value is generated. When a data temporary storage node receives new project data or task data or receives data backup of other data temporary storage nodes, the data index management module updates the data list and the index values. When the node monitoring module monitors the neighboring data temporary storage node, it checks the data list or the data list index value of the data temporary storage node and the neighboring data temporary storage node, and determines whether the corresponding project task data has the same project task code. In some embodiments of the present invention, when the node monitoring module cannot find that two or more data temporary storage nodes and the belonging data temporary storage node have a backup of a certain data, for example, the project task code of one piece of data cannot be found in the data list or the data list index of other data temporary storage nodes, the data is backed up to the neighboring data temporary storage node, and the data is recorded in the blockchain by the blockchain data module. In some embodiments of the present invention, if the node monitoring module finds that part of the data of the two or more data temporary storage nodes has the same project task code, for example, the data list or the data list index has a part corresponding to the same project task code, one data temporary storage node is selected as the source of the project task data, and the same project task code data of the neighboring data temporary storage node is used as a backup, which is recorded in the blockchain by the blockchain data module, and will be backed up from the project task data source to the neighboring data temporary storage node in the future. In the embodiment of the present invention, the data temporary storage node with the newer data time is selected as the source of the project task data. If the blockchain already has the record of the source of the project task data, the data is no longer selected.

The data temporary storage node has a blockchain data module, which is responsible for uploading the new data list index value generated by the data index management module to the blockchain, and uploading the backup information to the blockchain after the data is backed up. In addition, the blockchain data module records information regarding which data temporary storage node assigns which project task to which computing resource on the blockchain, and the work certificate of the computing resource that completes the computing task.

When the computing resource returns the project task computing result, the project task processing module compares the project task code. If the project task code is previously allocated to the computing resource, the project task processing module checks whether the recovery of the project task computing result is complete or not. If only part of project task computing result is received, that is the project task computing result has not been fully recovered, it is continue to wait for the computing resource to return the project task computing result. The computing resource management module continuously monitors the state of the computing resource, and determines whether the computing resource is not completed in time according to the computing deadline for the project task determined by the project task processing module. If the project task processing module does not receive the complete project task computing result, the project task processing module searches for the backup of the project task computing result in the blockchain via the blockchain data module. If the backup cannot be found in the blockchain, the project task processing module notifies that the computing of the project task by the computing resource failures to the computing resource management module, and the project task processing module re-publishes the project task on the blockchain network via the blockchain data module. If the project task computing result is completely recovered, the project task processing module returns the task result after computing to the user application, and issues a work certificate to the computing resource, and the work certificate is uploaded to the blockchain by the blockchain data module.

The data temporary storage node has a fee processing module. When the data temporary storage node successfully returns the task data after computing to the user application, the fee processing module requests the asset account management module of the user application to pay the corresponding rewards. The fee processing module will also dispatch the reward to the asset account of each computing resource owner participating in the project computing, and the blockchain data module will record the transaction information to the blockchain.

Each of the above modules is a software procedure executed on the data temporary storage node, or the software is matched with the hardware to implement the above functions of the data temporary storage node.

Third, the blockchain: the blockchain network records the relevant information of each part of the distributed management system, including (1) the information of the project data uploaded by the user application, wherein the information including user information, a project description, a project brief, a project file size, an upload time, and the like. When the user agrees to start the project computing, the data temporary storage node will record the relevant information of the project in the blockchain; (2) the state information uploaded by the data temporary storage node. When a data temporary storage node backs up data to other data temporary storage nodes, it will upload backup related information, including source node information (host information, MAC address, IP address), target node information, a number of the backup data, a backed-up data content index, a backup time, and node information of the existed same data. In addition, if a data temporary storage node is offline, other data temporary storage nodes which detects the offline node will upload relevant information, including the time when the node leaves the system, and the reason for leaving the system; (3) task record information of which computing resources with which assigned project tasks, wherein the task record information includes: a project task code, a project task source (data temporary storage node), and an acquisition time of project task of the computing resource. The blockchain data module of the data temporary storage node uploads the task record information to the blockchain; (4) return task information regarding the project task computing results returned after the successful computing of the computing resources, wherein the return task information includes: the project task code, the task source (data temporary storage node), and a computing resource return time. The data temporary storage node will upload the return task information to the blockchain after receiving the result returned by the computing resources; (5) The project task data obtained from the neighboring data temporary storage node by the computing resource, and the returned project task result when successful computing; (6) records regarding failures of the project task computing by the computing resource. The data temporary storage node which dispatches the project task detects the state of the computing resource. If the function is lost, and it is unable to detect, it is detected by the neighboring data temporary storage node, and it is determined whether the project task computing of the computing resource is time out or not, and no response from the computing resource according to the computing deadline set when the task is dispatched. If the data temporary storage node detects that the computing resource has timed out or leaves the system, the related information is recorded in the blockchain; (7) When a data temporary storage node is disconnected, and leaves the system due to various factors (natural disasters, human operations), the neighboring data temporary storage node will detect the data temporary storage node abnormality, and record the disconnection related information in the blockchain; (8) when a data temporary storage node returns the completed project task result to the user application, the data temporary storage node will transmit the work certificate to the computing resource that returns the project task result, and the work certificate is recorded in the blockchain. The content of the work certificate has the project initiator identity certificate, the project initiator information, the project description, the project profile, the project file size, the assigned project task description, the assigned project task brief, the data size of the assigned project task, the computing resource identity certificate of the returned computing result, the start time of the computing, the end time of the computing, and the total computing amount of the computing task.

Fourth, the computing resource: the computing resource is a computing device connected to the data temporary storage node in the blockchain network, and the computing resource executes a computing resource program which is compatible with the distributed management system. When the computing resource executes the computing resource program and connects to the Internet, a procedure for searching the neighboring data temporary storage node is executed, the information of the computing resource is uploaded to the neighboring data temporary storage node, and the state of the computing resource is periodically reported, so that the neighboring data temporary storage node can manage the computing resources within the management scope. When the computing resource starts to perform the task computing, it will also periodically report the current working progress, so that the neighboring data temporary storage node can know the progress. The computing resource program can be an application, some functions of the operating system, plug-ins, or other types of software programs and the combinations.

When the computing resource is idle or has redundant computing power, the computing resource can update the current pending project list according to the content recorded in the blockchain. The computing resource program executes a determining procedure to select the project task that can be undertaken, and displays the project task that can be undertaken to the user who manages the computing resources for deciding whether to undertake the project task computing. In some embodiments of the present invention, the computing resource may download the project data from the data temporary storage node after the user decides to undertake the project, or automatically start downloading the available project task data after the project task that can be undertaken is selected by the determining procedure.

In some embodiments of the present invention, the computing resource program has a graphical user interface, and can graphically display project tasks that are currently available for computing of the neighboring data temporary storage node according to the project task list, request to download the project task data from the neighboring data temporary storage node, and assign the project task to the corresponding computing resource. When the computing resource completes the download of the project task data, the downloaded file is decrypted or decompressed. If the user decides to undertake the project task or the system sets to automatically start the computing, the task computing is started immediately. In some embodiments of the present invention, the computing resource needs to obtain a decryption key, a complete algorithm (Executive), and project task data (Data) to start performing a task computing.

In some embodiments of the present invention, computing manners of different quotations provided by the computing resource can be registered in the data temporary storage node. For example, the computing resource uses only a dedicated processor such as a graphics processor or an idle computing power to compute a project task, or the computing resource uses all the computing power including the central processing unit to compute the project task. Since the two modes can provide different computing powers, the computing resources can generate different quotations for different computing modes, and transfer the computing powers and the corresponding quotations of different computing modes to the data temporary storage node, so that the project task processing module can accordingly dispatch tasks.

After completing the project task computing, the computing resource returns the computing result to the data temporary storage node, and uploads the acquired project task data, the task information, and the computing result of the data temporary storage node to the blockchain.

After the computing of the project task is completed, the computing resource returns the result to the data temporary storage node, and uploads the project task computing result to the blockchain to create a backup. After the data temporary storage node verifies whether the task is successfully completed, the computer resource can receive the work certificate, wherein the work certificate should include the project initiator identity certificate, the project initiator information, the project description, the project brief, the project file size, the assigned project task description, the assigned project task brief, the size of the assigned project task data, the computing resource identity certificate for the uploaded computing result, the start time of the computing, the end time of the computing, and the total computing amount of the computing task. When the data temporary storage node verifies that the complete computing result of the task is correct, and the computing result is sent to the user application of the project, the user application is requested to pay the reward, and the reward for completing the computing task is paid to the asset account corresponding to the computing resource.

Fifth, system operation process: The distributed management system will execute various operation processes, including processing for user application to upload project, computing resource registration, synchronization step, and project processing flow, which will be explained as follows.

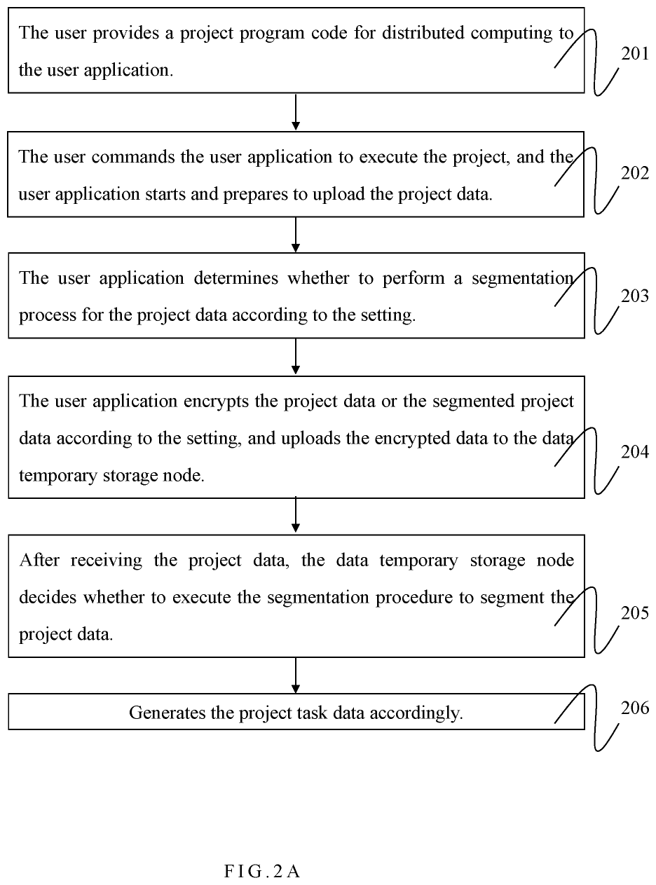

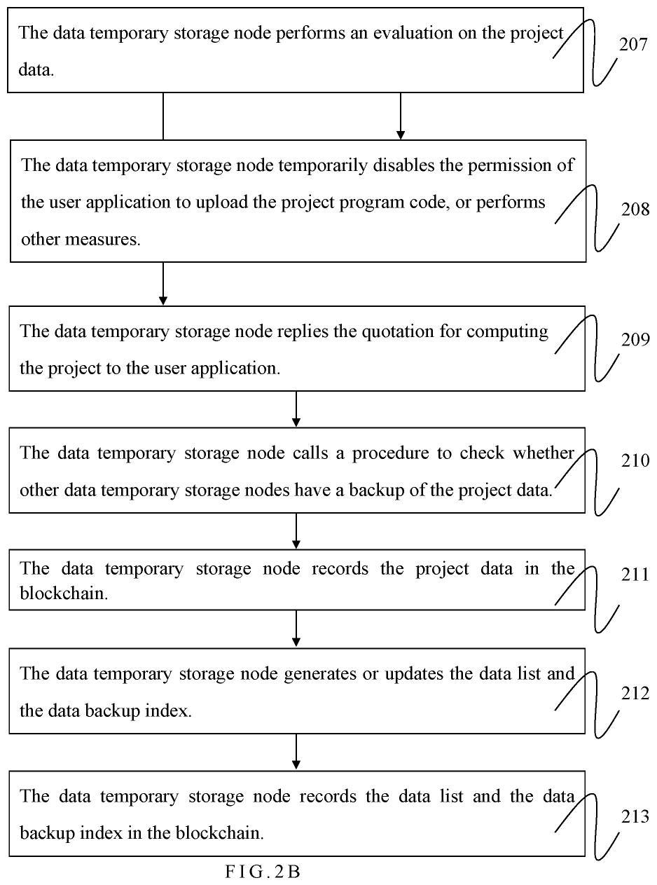

As shown in FIG. 2A and FIG. 2B, FIG. 2A and FIG. 2B are flowcharts showing the steps of a method for a user to upload a project in an embodiment of the present invention. The user can enable the user application after identity authentication. In step 201, the user provides a project program code for distributed computing to the user application. For example, the user can write the code via the user application, or obtaining the edited program code using other manners. In step 202, the user commands the user application to execute the project, and the user application starts and prepares to upload the project data. Then, in step 203, the user application determines whether to perform a segmentation process for the project data according to the setting. If the segmentation process is performed, the user application segments the project data into equal parts of the same size, or performs the segmentation process according to other segmentation manners. In step 204, the user application encrypts the project data or the segmented project data according to the setting, and uploads the encrypted data to the data temporary storage node. In step 205, after receiving the project data, the data temporary storage node decides whether to execute the segmentation procedure to segment the project data, and in step 206, generates the project task data accordingly. If the user application has segmented the project data, the data temporary storage node may not perform the segmentation procedure, otherwise the data temporary storage node may perform the segmentation procedure according to the computing power provided by the computing resources within the management scope.

In step 207, the data temporary storage node performs an evaluation on the project data. The data temporary storage node may randomly perform evaluation on selected parts of the segmented project task data according to the total computing amount, or select the project data using other manners for evaluation. During the evaluation, it is determined whether the project data contains malicious codes or error data. When the evaluation finds malicious codes in the project data, the computing is terminated, and the procedure goes to step 208. In step 208, the data temporary storage node temporarily disables the permission of the user application to upload the project program code, or performs other measures. If no error or malicious code is found after the evaluation, in step 209, the data temporary storage node replies the quotation for computing the project to the user application, and the user application prompts the user to determine whether to start the project computing.

If the user agrees to perform the project computing, in step 210, the data temporary storage node calls a procedure to check whether other data temporary storage nodes have a backup of the project data. When two or more data temporary storage nodes having the backup of the project data are not found, the data temporary storage node backs up the project data to the neighboring data temporary storage node. If two or more data temporary storage nodes having the backup of the project data are found, one of the data temporary storage node is selected as the original data temporary storage node, and the same project data in the neighboring data temporary storage node is used as a backup. Then, in step 211 and step 212 are performed. In step 211, the data temporary storage node records the project data in the blockchain, wherein the project data includes the project initiator information, the project description, the project brief, the project file size, and the upload time. In step 212, the data temporary storage node generates or updates the data list and the data backup index. When the data temporary storage node receives new project data or task data and backs up the data to other data temporary storage nodes, or when the data temporary storage node receives the data backup of other data temporary storage nodes, the data list and data backup index are updated. In step 213, the data temporary storage node records the data list and the data backup index in the blockchain. The content comprises the data source node information (host information, MAC address, IP address), the backup node information, the number of the backup data, the data content index of the backup, the backup time, and the node information having the same data.

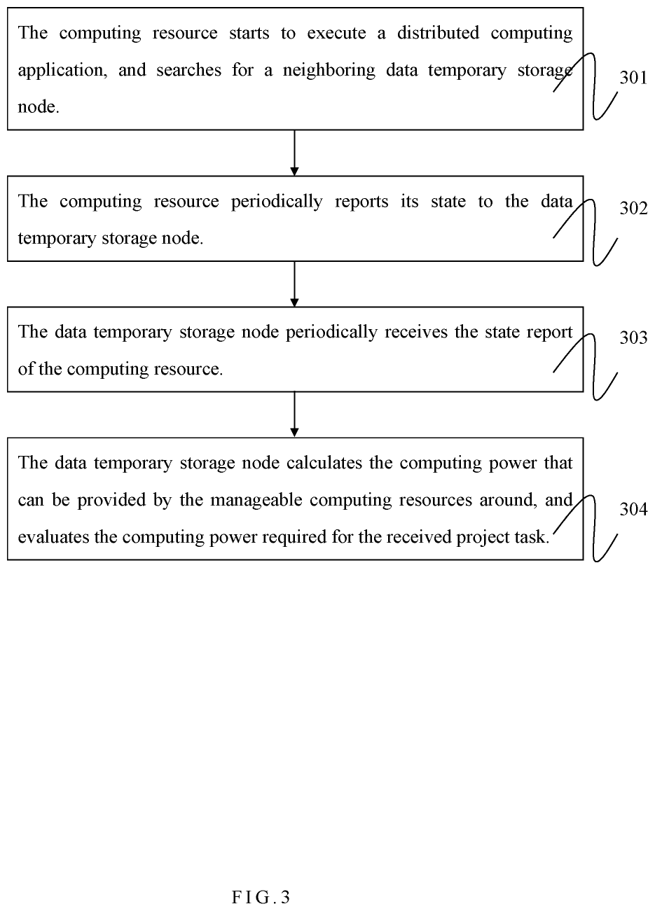

As shown in FIG. 3, FIG. 3 is a flow chart of a method for a user to register a computing resource according to an embodiment of the present invention. In step 301, the computing resource starts to execute a distributed computing application, and searches for a neighboring data temporary storage node. After that, the computing resource establishes a connection with the found data temporary storage node, and uploads related information of itself to the data temporary storage node. In step 302, the computing resource periodically reports its state to the data temporary storage node. When the computing resource undertakes a project task from the data temporary storage node, the computing resource also periodically reports the working progress to the data temporary storage node. In step 303, the data temporary storage node periodically receives the state report of the computing resource. If the computing resource does not reply its state before the deadline several times, the data temporary storage node determines that the computing resource is offline or not in the management scope. If the computing resource times out several times after receiving the project task, the data temporary storage node determines that the project task computing performed by the computing resource fails. In step 304, the data temporary storage node calculates the computing power that can be provided by the manageable computing resources around, and evaluates the computing power required for the received project task. The statistical information is used as the basis for (1) how the data temporary storage node segments the project. The data temporary storage node can segment the project according to the lowest maximum available computing power among the surrounding computing resources, or according to the maximum computing power of the largest number of machines in the surrounding computing resources. One way is to let each computing resource have the ability to undertake project tasks, and the other way is to let the most machines fully utilize the computing power; and (2) evaluating whether the workload is saturated by the data temporary storage node. When the data temporary storage node finds that the computing power required for the received project task has exceeded the computing power that can be provided by the surrounding manageable computing resources, it will enter a saturated state, and the data temporary storage node will transfer the unprocessed project data or the divided project task to the neighboring data temporary storage node, and delete the unprocessed project data or project task to avoid erroneous assignment to other computing resources.

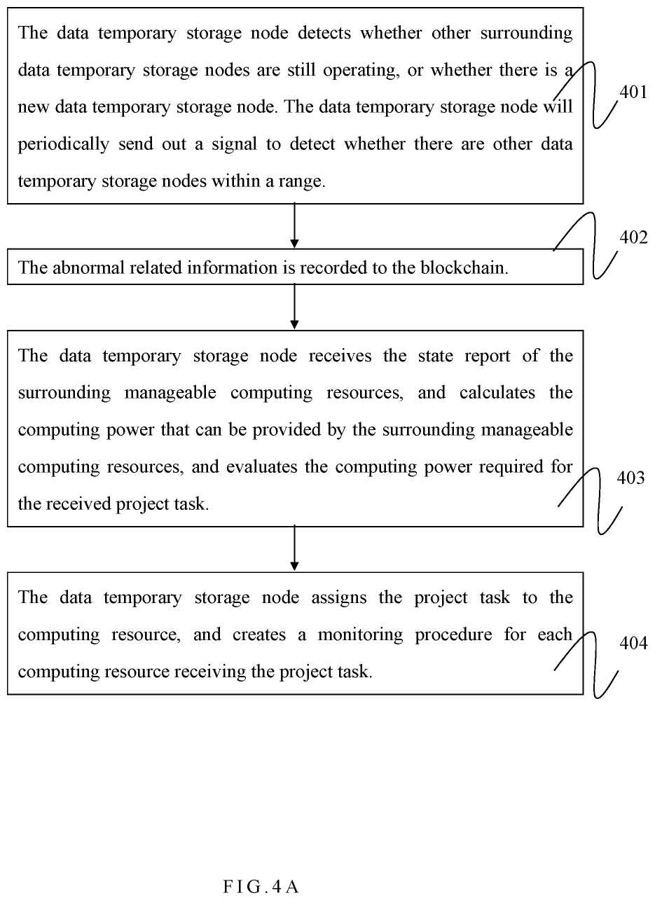

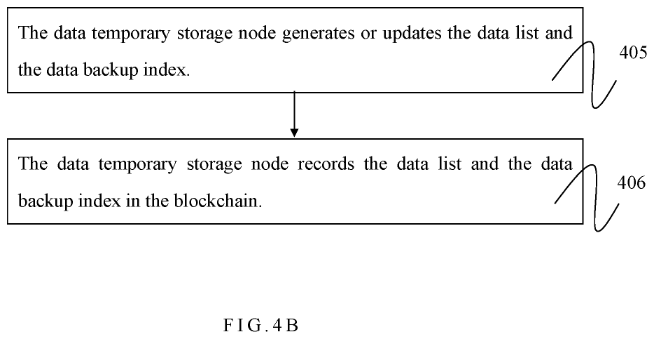

As shown in FIG. 4A and FIG. 4B, FIG. 4A and FIG. 4B are schematic diagrams showing the steps of synchronizing the data temporary storage node with other devices or nodes according to an embodiment of the present invention, wherein steps 401, 403, 404, and 405 simultaneously perform. In step 401, the data temporary storage node detects whether other surrounding data temporary storage nodes are still operating, or whether there is a new data temporary storage node. The data temporary storage node will periodically send out a signal to detect whether there are other data temporary storage nodes within a range. If the data temporary storage node finds that a certain data temporary storage node is abnormal, for example, the node is disconnection, and leaves the system, in step 402, the abnormal related information is recorded to the blockchain, wherein the information comprises abnormal node information, abnormal time, abnormal cause, and the like. In step 403, the data temporary storage node receives the state report of the surrounding manageable computing resources, and calculates the computing power that can be provided by the surrounding manageable computing resources, and evaluates the computing power required for the received project task. The statistical information is used as the basis for (1) how the data temporary storage node segments the project; and (2) evaluating whether the workload is saturated by the data temporary storage node. When the data temporary storage node finds that the computing power required for the received project task has exceeded the computing power that can be provided by the surrounding manageable computing resources, it will enter a saturated state, and the data temporary storage node will transfer the unprocessed project data or the divided project task to the neighboring data temporary storage node, and delete the unprocessed project data or project task to avoid erroneous assignment to other computing resources. In step 404, the data temporary storage node assigns the project task to the computing resource, and creates a monitoring procedure for each computing resource receiving the project task, wherein the monitoring procedure monitors whether the computing resource receiving the project task has exceeded the computing deadline, whether the assigned project task has reached the maximum allocation number, the state of the computing resource, and the like. In step 405, the data temporary storage node generates or updates the data list and the data backup index. When the data temporary storage node receives the new project data or task data and backs up the data to other data temporary storage nodes, or receives the data backup of other data temporary storage nodes, the data list and the data backup index will be updated. In step 406, the data temporary storage node records the data list and the data backup index in the blockchain, wherein the content includes the data source node information (host information, MAC address, IP address), the backup node information, the number of backup data, the data content index of the backup, the backup time, and the node information having the same data.

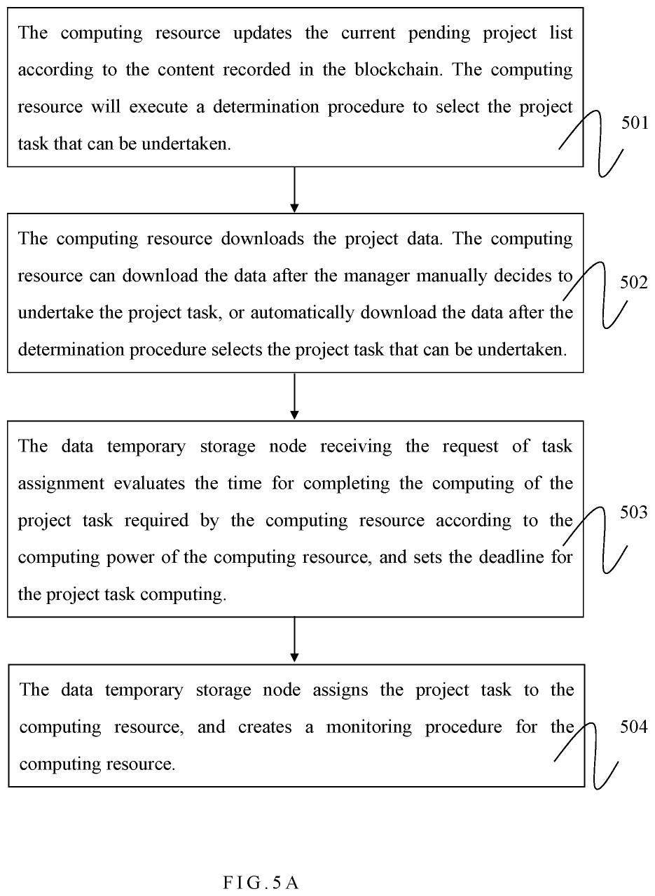

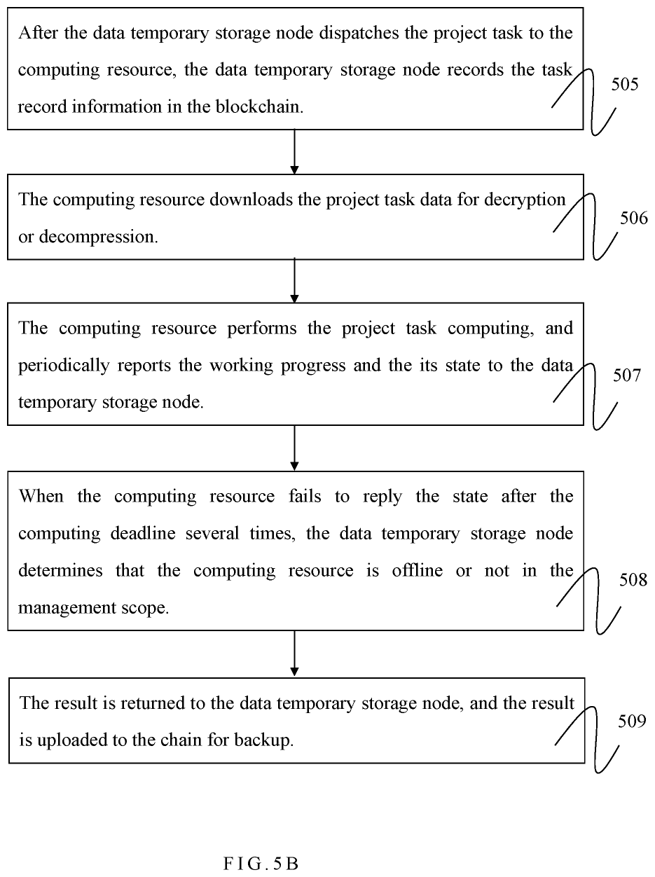

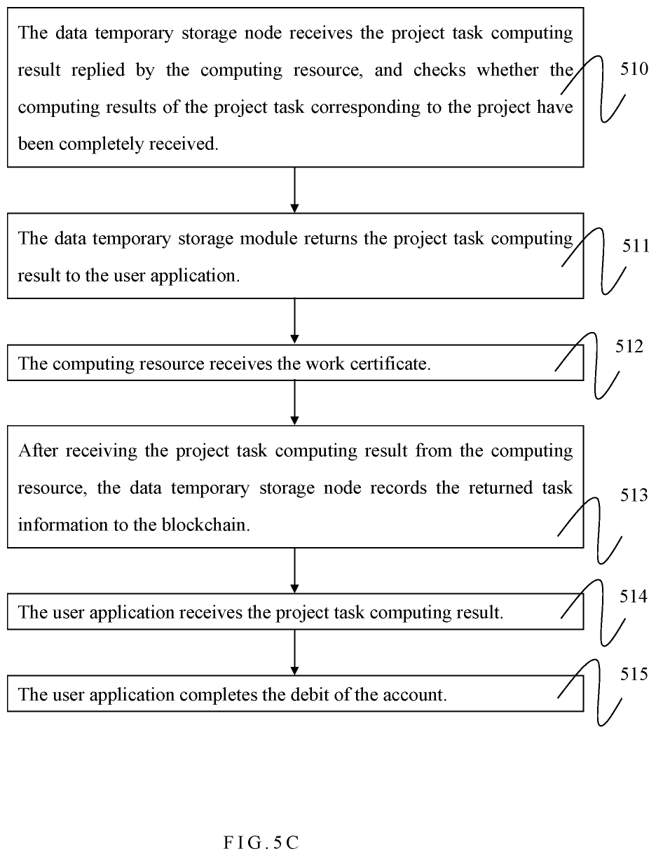

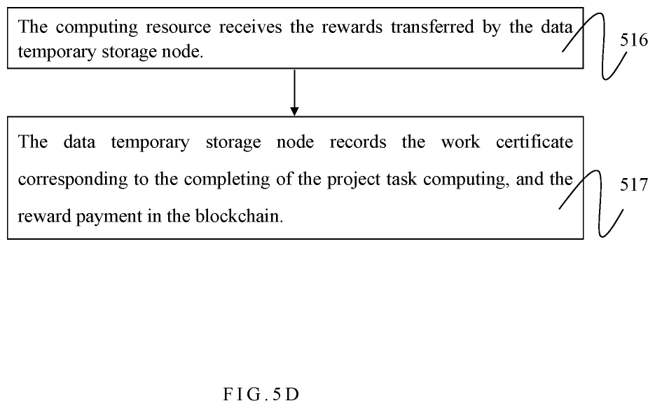

As shown in FIG. 5A to FIG. 5D, FIG. 5A to FIG. 5D are flow charts showing the steps of processing a project of the distributed computing method in an embodiment of the present invention. In step 501, the computing resource updates the current pending project list according to the content recorded in the blockchain. The computing resource will execute a determination procedure to select the project task that can be undertaken, and display the list of the project task that can be undertaken to the user who manages the computing resource. The user can decide whether to undertake the project task. In step 502, the computing resource downloads the project data. The computing resource can download the data after the manager manually decides to undertake the project task, or automatically download the data after the determination procedure selects the project task that can be undertaken. The computing resource can graphically display project tasks that are currently available for computing of the neighboring data temporary storage node according to the project task list, and ask the manager whether to accept the project task. The computing resource requests the assignment of the project task to the neighboring data temporary storage node, and the provision of the project task data. In step 503, the data temporary storage node receiving the request of task assignment evaluates the time for completing the computing of the project task required by the computing resource according to the computing power of the computing resource, and sets the deadline for the project task computing. In step 504, the data temporary storage node assigns the project task to the computing resource, and creates a monitoring procedure for the computing resource. The monitoring procedure monitors whether the computing deadline has been exceeded or not after the computing resource received the project task, whether the assigned project task has reached the maximum allocation number, the state of the computing resource, and the progress of the project processing, and others. If the computing deadline has not been exceeded, it is continued to monitor the working state of the computing resource. If the computing deadline has been exceeded, the data temporary storage node searches for a backup of the project task computing result in the blockchain. If the backup cannot be found, the project task that has not completed after the computing deadline is assigned to other computing resources, and the failure of the original computing resource is recorded. If the maximum number of assignments has been reached after the task assignment, the data temporary storage node will not assign the project task to other computing resources. Then, step 505 and step 506 are performed. In step 505, after the data temporary storage node dispatches the project task to the computing resource, the data temporary storage node records the task record information in the blockchain, wherein the content includes the project task code, the source of the project task (data temporary storage node), and the acquisition time of the computing resource for receiving the project task. When the computing resource does not reply after the computing deadline, the data temporary storage node determines that the computing of the computing resource fails, and records related information to the blockchain. If the data temporary storage node detects that the computing resource leaves the system due to other factors, related information is also recorded in the blockchain. If the data temporary storage node that publishes the project task to the computing resource cannot perform this step, the neighboring data temporary storage node replaces the data temporary storage node to detect the computing resource. In step 506, the computing resource downloads the project task data for decryption or decompression, wherein the project task data includes a decryption key, a complete algorithm (Executive), and a project task data (Data). If the manager has decided to undertake the project task or the system sets to automatically perform the computing, the task computing is started immediately. In step 507, the computing resource performs the project task computing, and periodically reports the working progress and the its state to the data temporary storage node. If the computing resource is abnormal, the data temporary storage node performs step 508. In step 508, when the computing resource fails to reply the state after the computing deadline several times, the data temporary storage node determines that the computing resource is offline or not in the management scope. When the computing resource fails to reply the working progress several times, the data temporary storage node determines that the computing of the project task by the computing resource fails.

When the computing resource completes the project task computing, in step 509, the result is returned to the data temporary storage node, and the result is uploaded to the chain for backup. In step 510, the data temporary storage node receives the project task computing result replied by the computing resource, and checks whether the computing results of the project task corresponding to the project have been completely received. If only a part of the computing results is received, it is continued to wait other computing results provided by the computing resource. If all the computing results of the project task have been received, the data temporary storage module returns the project task computing result to the user application uploading the project, and executing the procedure for assigning the project to the computing resource. In step 511, the data temporary storage module returns the project task computing result to the user application, and asks the user application to pay the rewards, so as to transfer the amount of the project rewards from the account of the user application to the data temporary storage node, and issue a work certificate to the computing resource completing the project task. Then, steps 512, 513 and 514 are performed. In step 512, the computing resource receives the work certificate, wherein the work certificate has the project initiator identity certificate, the project initiator information, the project description, the project brief, the project file size, the assigned project task description, the assigned project task profile, the assigned project task data size, the identity certificate for the computing resource returning the computing result, the start time of the computing work, the end time of the computing work, and the total computing amount of the computing task. In step 513, after receiving the project task computing result from the computing resource, the data temporary storage node records the returned task information to the blockchain, wherein the return task information includes: the project task code, the task source (data temporary storage node), and the return time corresponding to the computing resource. In step 514, after receiving the project task computing result, the user application performs the following steps: (1) comparing and verifying whether the project task computing result belongs to the assigned project task data; (2) sending a successful received message to the data temporary storage node after the verification of the task result is correct; (3) confirming whether all the project task computing results have been successfully received. If not, it is continued to wait for other project task computing results of the same project; (4) paying the project task fee from the uses account; (5) combining and decrypting the project task computing results after receiving all the project task computing results; (6) setting the user as accessible to obtain or own the project task computing result after paying all the project task fees. Then, in step 515, the user application completes the debit of the account, and the data temporary storage node pays the rewards corresponding to the completing of the project task computing to the asset account corresponding to the computing resource. Then, steps 516 and 517 are performed. In step 516, the computing resource receives the rewards transferred by the data temporary storage node. In step 517, the data temporary storage node records the work certificate corresponding to the completing of the project task computing, and the reward payment in the blockchain.

The above distributed computing method has a plurality of data temporary storage nodes. The user application can connect to the neighboring data temporary storage node to upload the project data or task to be processed. The data temporary storage node publishes the project task in the blockchain, and looks for computing resources or other data temporary storage nodes for processing. The data temporary storage node will sample and evaluate the project tasks, and evaluate the quotation for the computing power required for processing the project task. After the project uploader agrees to the quotation, the project is dispatched to the computing resource undertaking the project task. The computing resource can be freely connected to the neighboring data temporary storage node to register and undertake the project task. When the project task is completed, the computing resource can obtain the rewards and the work certificate from the data temporary storage node. In the distributed computing management procedure of the entire project, the upload of project data, the assignment of project task, the report of task results, the reward payment and collection, and other abnormal errors are recorded in the blockchain, thereby ensuring data security and reducing user risk and cost.

The distributed computing methods, may take the form of a program code (i.e., executable instructions) embodied in tangible media, such as floppy diskettes, CD-ROMS, hard drives, or any other machine-readable storage medium, wherein, when the program is loaded into and executed by a machine, such as a computer, the machine thereby becomes an apparatus for executing the methods. The methods may also be embodied in the form of a program transmitted over some transmission medium, such as electrical wiring or cabling, through fiber optics, or via any other form of transmission, wherein, when the program is received and loaded into and executed by a machine, such as a computer, the machine becomes an apparatus for executing the disclosed methods. When implemented on a general-purpose processor, the program combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalent.

What is claimed is:

1. A distributed computing method, comprising:
a. a user application providing a dividable project data, wherein the project data comprises a project program and a project code, and the user application or at least one of a plurality of neighboring data temporary storage nodes segments the project data into a plurality of project tasks, wherein each of the project tasks has a task code and the project code;
b. the user application uploading the dividable project data or the project tasks with a project execution file to the at least one neighboring data temporary storage node;
c. receiving a project processing cost value from the at least one neighboring data temporary storage node by the user application;
d. if the user application agrees the project processing cost value from the at least one neighboring data temporary storage node, the at least one neighboring data temporary storage node respectively connecting to at least one of a plurality of computing resources, then publishing and recording on a blockchain network, the at least one computing resource receives one of the project tasks and the project execution file to compute from the blockchain network;
e. the at least one neighboring data temporary storage node receiving a plurality of project task computing results from the at least one computing resource, wherein the project task computing results respectively have the task code and the project code, the at least one neighboring data temporary storage node checking the project task computing results according to the task code, and the neighboring data temporary storage node publishing a work certificate to the at least one computing resource, and recording the work certificate in the blockchain network;
f. the user application receiving the project task computing results returned by the at least one neighboring data temporary storage node, and checking whether the project code in the respective project task computing results is consistent or not;
g. the user application combining the project task computing results according to the task code, thus to generate a project processing result, and checking whether the project processing result meets the dividable project data;
h. if the user application checks that the project processing result is correct, the user application paying the project processing cost value from an account, wherein the account belongs to a user who passes an identity authentication, and the user application recording a payment record of the project processing cost value in the blockchain network; and
i. allowing the user who passed the identity authentication to access the project processing result.

2. A user application device of a distributed computing system for executing a user application program, comprising:
an identity authentication module, authenticating a user identity;
a user interface, wherein the user interface is enabled when the user passed the identity authentication through the identity authentication module;
a project data processing module, generating a project data comprising a project code according to user operation for the user interface; and
an asset account management module, linking to an account of the user,
wherein the project data processing module connects to at least one of a plurality of neighboring data temporary storage node, and performs the following steps:
uploading the project data or a plurality of project tasks generated by segmenting the project data to the at least one neighboring data temporary storage node, and publishing the project tasks via a blockchain network;
receiving a plurality of project task computing results from the at least one neighboring data temporary storage node, checking whether the project code in the respective project task computing results is consistent or not, and returning a verification success message to the plurality of neighboring data temporary storage nodes if the respective project task computing results have the project code;
confirming whether the project task computing results have been completely received, and if the project task computing results have been completely received, combining the project task computing results; and
setting the user is accessible to the project task processing result.

3. The user application device of claim 2, wherein the project data processing module further performs the following steps:
receiving a project processing cost value from the neighboring data temporary storage nodes;
sending a message agreeing to the project processing cost value to the neighboring data temporary storage nodes, and publishing the project tasks; and
if the user application checks that the project task computing results are correct, requesting the asset account management module to pay the project processing cost value by the account of the user, and recording a payment record of the project processing cost value in the blockchain network.

4. The user application device of claim 3, wherein the project data processing module further performs the following steps:
the project data processing module determining whether to execute a project data segmentation process; and
executing the project data segmentation process to generate the project tasks from the project data, wherein the respective project tasks have the project code and a task code.

5. A data temporary storage node of a distributed computing system, comprising:
a node monitoring module detecting a working state of at least one neighboring data temporary storage node;
a project task receiving module receiving a project data or a plurality of project tasks from at least one user application or the neighboring data temporary storage node, wherein the project data or the project tasks have a project code;
a computing resource management module detecting the working state of at least one computing resource, and calculating a computing power of the at least one computing resource, wherein the computing resource connects to the data temporary storage node;
a project task processing module determining whether the at least one computing resource can process the project data or the project tasks received by the project task receiving module according to computing power of the at least one computing resource calculated by the computing resource management module, and assigning one of the project tasks to one of the at least one computing resource or the neighboring data temporary storage node;
a data index management module updating a data list index according to the project data or the project tasks received by the project task receiving module, wherein a part of the data list index represents the project code; and
a blockchain data module recording the data list index and information regarding the assignment between one of the project tasks and one of the at least one computing resource or the neighboring data temporary storage node to a blockchain network, wherein the at least one computing resource belongs to the blockchain network.

6. The data temporary storage node of the distributed computing system of claim 5, further comprising:
a fee processing module requesting the at least one user application to pay a project task processing fee,
wherein the project task processing module has a project data evaluation sub-module, and the project data evaluation sub-module performs an evaluation on the project data or the project tasks, evaluates a computing power requirement required for the project data or the project tasks, and generates a quotation of the project task processing fee based on the computing power requirement and the computing power of the least one computing resource.

7. The data temporary storage node of the distributed computing system of claim 6, wherein the fee processing module pays the project task processing fee paid by the at least one user application to one of the at least one computing resource, wherein a portion of the at least one computing resource has completed the computing of one of the project tasks.

8. The data temporary storage node of the distributed computing system of claim 5, wherein when the project task receiving module receives the project data, the project task processing module segments the project data to generate the project tasks according to the computing power of the at least one computing resource calculated by the computing resource management module, in which the respective project tasks have the same project code and a task code.

9. The data temporary storage node of the distributed computing system of claim 5, wherein when the project task processing module assigns one of the project tasks to one of the at least one computing resource, the project task processing module creates a monitoring procedure and sets a computing deadline, and the monitoring procedure monitors whether the at least one computing resource does not reply a computing result within the computing deadline.

10. The data temporary storage node of the distributed computing system of claim 9, wherein when the project task processing module assigns one of the project tasks to one of the at least one computing resource, the project task processing module records a number of assignments corresponding to one of the project tasks, and the monitoring procedure monitors whether the number of assignments corresponding to one of the project tasks has reached a maximum number of assignment, and if so, the project task processing module stops assigning one of the project tasks.

11. The data temporary storage node of the distributed computing system of claim 5, wherein the node monitoring module reads the data list index of the at least one neighboring data temporary storage node, and the node monitoring module compares the data list index of the least one neighboring data temporary storage node with the data of the data temporary storage node, and the data list index is updated by the index management module, if the part of the data list index representing the project code is not in the data list index of the at least one neighboring data temporary storage node, the project tasks with the project code are backed up to the neighboring data temporary node.

12. The data temporary storage node of the distributed computing system of claim 11, wherein the blockchain data module records a backup related record in the blockchain network.

13. The data temporary storage node of the distributed computing system of claim 5, wherein if the computing resource management module does not receive the working state of the at least one computing resources several times, the computing resource management module determines that one of the at least one computing resource is offline.

14. The data temporary storage node of the distributed computing system of claim 6, wherein when a malicious code is found in the project data or the project tasks during the evaluation, the evaluation is stopped.

15. The data temporary storage node of the distributed computing system of claim 9, wherein if one of the at least one computing resource does not return the computing result after the computing deadline, or the computing results are not completely received, the project task processing module searches for a backup of the computing result in the blockchain via the blockchain data module.

16. The data temporary storage node of the distributed computing system of claim 9, wherein if one of the at least one computing resource does not return the operation result after the computing deadline, or the computing results are not completely received, the project task processing module re-assigns the project task corresponding to the computing result.

17. The data temporary storage node of the distributed computing system of claim 5, wherein the node monitoring module reads the data list index of the at least one neighboring data temporary storage node, and the node monitoring module compares the data list index of the at least one neighboring data temporary storage node with the data of the data temporary storage node, and the data list index is updated by the index management module, if the comparison finds that the same project task code commonly existed, one of the at least one neighboring data temporary storage node and the data temporary storage node is determined as a data source of the project tasks corresponding to the project task code.
